(19) United States
(12) Patent Application Publication
(10) Pub. No.: US 2026/0227620 A1
(43) Pub. Date: Aug. 6, 2026

(54) METHODS AND APPARATUS FOR FOURIER PTYCHOGRAPHY MICROSCOPY USING CODED ILLUMINATION

(71) Applicant: Siemens Healthcare Diagnostics Inc., Tarrytown, NY (US)

(72) Inventors: Abhijeet A. JOSHI, Bangalore (IN); Tejas S SHAH, Hyderabad (IN); Mohiudeen AZHAR, Bangalore (IN)

(73) Assignee: Siemens Healthcare Diagnostics Inc., Tarrytown, NY (US)

(21) Appl. No.: 19/152,128

(22) PCT Filed: Jan. 29, 2024
(86) PCT No.: PCT/US2024/013364

§ 371 Date: Jul. 30, 2025

(30) Foreign Application Priority Data
Jan. 30, 2023 (IN) 202311005911

(51) Int. Cl. G02B 21/36; G02B 21/12

(52) U.S. Cl. CPC G02B 21/367; G02B 21/125

(57) ABSTRACT

A method of determining coding patterns for light sources of an FPM system is provided that includes determining a coding matrix that specifies light source patterns for multiplexed low resolution images. Multiplexed low resolution images are generated using the coding matrix. High resolution amplitude and phase reconstruction is performed using an FPM algorithm and the multiplexed low resolution images. A total loss function that includes an exclusivity coupling regularization term that promotes diversity of light source patterns and sparse groupings of light sources within light source patterns of the coding matrix is computed. The method also includes determining if coding matrix optimization is complete. If the coding matrix optimization is complete, the method includes storing the optimized coding matrix for use by the FPM system and/or employing the optimized coding matrix during use of the FPM system.

### CROSS-REFERENCE TO RELATED APPLICATIONS

This application is the National Phase under 35 U.S.C. § 371 of PCT International Application No. PCT/US2024/013364, which has an international filing date of Jan. 29, 2024, which designated the United States of America, and which claims priority to Indian Patent Application No. 202311005911, filed Jan. 30, 2023, the entire contents of each of which are hereby incorporated herein by reference.

### FIELD

The present application relates to sample imaging, and, more particularly, to methods and apparatus for Fourier ptychography microscopy using coded illumination.

### BACKGROUND

Fourier ptychography microscopy (FPM) is a microscopy technique that allows high resolution imaging over a wide field of view. FPM employs an array of light sources to illuminate a sample during capture of a set of low resolution images. Each of the low resolution images is illuminated by a different light source or set of light sources from the array. The captured low resolution images are then stitched together in the Fourier domain to generate a high resolution image.

FPM provides a number of advantages over conventional microscopy such as a significantly higher space-bandwidth product, a simple, low-cost setup with few mechanical actuations, and a small footprint. However, due to the number of images that are to be captured, FPM suffers from long image acquisition times, which limits its applicability to imaging moving samples and video capturing. Reconstructing a high resolution image from the captured low resolution images may also be prohibitively time consuming in some applications.

Accordingly, a need exists for improved methods and apparatus for FPM.

### SUMMARY

In some embodiments, a method of determining coding patterns for light sources of an FPM system is provided. The method includes determining a coding matrix that specifies light source patterns for multiplexed low resolution images, generating multiplexed low resolution images using the coding matrix, and performing high resolution amplitude and phase reconstruction using an FPM algorithm and the multiplexed low resolution images. The method also includes computing a total loss function, where the total loss function includes an exclusivity coupling regularization term that promotes diversity of light source patterns and sparse groupings of light sources within light source patterns of the coding matrix. The method also includes determining if coding matrix optimization is complete. If the coding matrix optimization is complete, the method includes storing the optimized coding matrix for use by the FPM system and/or employing the optimized coding matrix during use of the FPM system.

In some embodiments, a method of determining coding patterns for light sources of an FPM system is provided. The method includes determining an initial coding matrix that specifies LED patterns for multiplexed low resolution images, generating single LED low resolution images, and generating multiplexed low resolution images using the coding matrix and the single LED low resolution images. The method also includes performing high resolution amplitude and phase reconstruction using an FPM algorithm and the multiplexed low resolution images, computing a total loss function, where the total loss function includes an exclusivity coupling regularization term that promotes diversity of light source patterns and sparse groupings of light sources within light source patterns of the coding matrix. The method also includes determining if coding matrix optimization is complete. If the coding matrix optimization is not complete, the method includes: updating the coding matrix based on the computed total loss function; generating updated multiplexed low resolution images using the updated coding matrix and the single LED low resolution images; performing high resolution amplitude and phase reconstruction using the FPM algorithm and the updated multiplexed low resolution images; computing an updated total loss function, where the updated total loss function includes the exclusivity coupling regularization term; and determining if coding matrix optimization is complete based on the updated total loss function.

In some embodiments, a Fourier ptychographic imaging system is provided. The Fourier ptychographic imaging system includes a plurality of light sources configured to emit light onto a sample location, an optical system configured to image at least a portion of a sample positioned at the sample location, and an image capture device configured to capture images of the sample through the optical system under different light conditions provided by the plurality of light sources. The Fourier ptychographic imaging system also includes a processor and a memory coupled to the processor. The memory includes a coding matrix that specifies light source patterns for use during capture of low resolution images by the image capture device, where the coding matrix includes light source patterns optimized using a loss function that includes an exclusivity coupling regularization term that promotes diversity of light source patterns and sparse groupings of light sources within light source patterns of the coding matrix. The memory also includes computer executable instructions stored therein that, when executed by the processor, cause the processor to obtain images of a sample positioned at the sample location. Each of the images is illuminated using a different light source pattern specified within the coding matrix. The computer executable instructions, when executed by the processor, also cause the processor to store the images and initiate FPM reconstruction to generate a reconstructed image based on the stored images.

A system of one or more computers may be configured to perform particular operations or actions by virtue of having software, firmware, hardware, or a combination thereof installed on the system that, in operation, causes or cause the system to perform the actions. In some embodiments, one or more computers may include one or more graphics processing units (GPUs). One or more computer programs may be configured to perform particular operations or actions by including instructions that, when executed by data processing apparatus, cause the apparatus to perform the actions.

Other features and aspects of the present invention will become more fully apparent from the following detailed description, the appended claims, and the accompanying drawings.

### BRIEF DESCRIPTION OF THE DRAWINGS

FIG. 1A illustrates an example FPM system provided in accordance with embodiments of the disclosure.

FIG. 1B illustrates an example light source array that may be employed with the FPM system of FIG. 1A in accordance with embodiments provided herein.

FIG. 2 illustrates an example method of determining a coding matrix for an FPM system in accordance with embodiments provided herein.

FIG. 3A illustrates LED patterns for an example initial coding matrix in accordance with embodiments provided herein.

FIG. 3B illustrates updated LED patterns for the example initial coding matrix described with reference to FIG. 3A following optimization through use of an exclusivity coupling regularization term in accordance with embodiments provided herein.

FIG. 4A illustrates an example, simulated ground truth image from which a plurality of low resolution, single-LED images may be generated in accordance with embodiments provided herein.

FIG. 4B illustrates example, low resolution, single-LED images generated from the simulated ground truth of FIG. 4A in accordance with embodiments provided herein.

FIG. 4C illustrates example multiplexed, low resolution images generated from the single-LED images of FIG. 4B based on a coding matrix in accordance with embodiments provided herein.

FIG. 4D illustrates an example high resolution, reconstructed image that may be generated from the multiplexed, low resolution images of FIG. 4C in accordance with embodiments provided herein.

FIGS. 5A and 5B illustrate example LED patterns following coding matrix optimization without and with an exclusivity coupling regularization term, respectively, in accordance with embodiments provided herein.

FIGS. 5C and 5D illustrate coding matrices corresponding to the LED patterns of FIGS. 5A and 5B, respectively, in accordance with embodiments provided herein.

FIG. 6A illustrates a graphical comparison of the mean square error (MSE) observed within a loss function during training with and without inclusion of an exclusivity coupling regularization term in accordance with embodiments provided herein.

FIG. 6B illustrates a graph of MSE versus training iterations during coding matrix optimization without and without use of an exclusivity coupling regularization term in accordance with embodiments provided herein.

FIG. 7 illustrates a first example method of determining coding patterns for light sources of an FPM system in accordance with embodiments provided herein.

FIG. 8 illustrates a second example method of determining coding patterns for light sources of an FPM system in accordance with embodiments provided herein.

FIG. 9 illustrates a flow diagram of a process and system for converting an initial coding matrix into an optimized coding matrix, and for use of the optimized coding matrix, in accordance with embodiments provided herein.

### DETAILED DESCRIPTION

Independent of the grammatical term usage, individuals with male, female, or other gender identities are included within the term.

As stated previously, while FPM provides a number of advantages, use of FPM may be limited in some applications due to the substantial length of time required to obtain results with this technique. The main delays associated with FPM include the time required to capture numerous low-resolution images and the time required to reconstruct a high-resolution image from captured low-resolution images. Embodiments provided herein may significantly reduce FPM image capture time, allowing FPM to be employed in a wider range of applications (e.g., any application that benefits from faster results, such as imaging a moving sample, clinic testing for medical diagnoses/treatment, or the like).

During FPM, a sample is illuminated by an array of light sources, where each light source (e.g., a light emitting diode (LED)) emits light toward the sample from a different angle and/or position. Low resolution images of the sample captured using different LEDs from the LED array are processed within the Fourier domain to generate a high resolution image (e.g., via amplitude and phase reconstruction based on the low resolution images).

Using a single LED at a time to illuminate the sample for each low resolution image is time consuming. To reduce image capture time during FPM, multiplexing or “coded illumination” techniques, in which different patterns (e.g., combinations) of LEDs within an LED array are employed to illuminate a sample during low resolution image capture, have been developed. Selecting the specific patterns of LEDs to employ for each low resolution image is, however, challenging without affecting reconstructed image quality. One approach to determining the LED patterns for image capture during FPM is described in M. Kellman, E. Bostan, M. Chen and L. Waller, “Data-Driven Design for Fourier Ptychographic Microscopy,” 2019 IEEE International Conference on Computational Photography (ICCP), 2019, pp. 1-8, doi: 10.1109/ICCPHOT.2019.8747339 (hereinafter “Kellman et al.”). Kellman et al. describe reducing the number of low resolution images needed for FPM image reconstruction through use of a neural network trained to learn LED multiplexing patterns. While effective, such an approach requires significant optimization and may converge slowly. Other example approaches for coded/multiplexed illumination are described in Lei Tian, Ziji Liu, Li-Hao Yeh, Michael Chen, Jingshan Zhong, and Laura Waller, “Computational illumination for high-speed in vitro Fourier ptychographic microscopy,” Optica 2, 904-911 (2015) and Lei Tian, Xiao Li, Kannan Ramchandran, and Laura Waller, “Multiplexed coded illumination for Fourier Ptychography with an LED array microscope,” Biomed. Opt. Express 5, 2376-2389 (2014). These and other coded/multiplexed illumination techniques would benefit from improved LED pattern selection for low resolution imaging during FPM.

In accordance with embodiments provided herein, a regularization term, referred to as an exclusivity coupling (EC) regularization term, is added to an FPM loss function used to determine FPM coded illumination patterns (e.g., the light source pattern used for each low resolution image). The EC regulation term may be employed to promote diversity in light source patterns, use of fewer light sources within light source patterns, and use of patterns with light sources that are more spatially separated as shown in equation (1):

$$EC Regularization Term = {λ}_{coupling} * Norm ( {CC}^{T} - diag ( {CC}^{T} ) * I ) \qquad ( 1 )$$

where C represents the coding matrix that defines the coding patterns for the light array during image capture, λ_{coupling} is a tunable hyperparameter that may be used to determine the strength of the exclusivity coupling, and I is an identity matrix. As described above, a larger λ_{coupling} value promotes diversity in light source patterns, use of fewer light sources within light source patterns, and use of patterns with light sources that are more spatially separated. Selection of λ_{coupling} may be based on trial and error, past experience with light source pattern selection for FPM, or the like (e.g., so as to promote pattern diversity and sparsity with image quality during coded illumination).

The exclusivity coupling regularization term of equation (1) may be employed with any suitable loss function used for FPM (e.g., a differentiable FPM loss function). With the addition of the exclusivity coupling (EC) regularization term, the total loss function (LF) becomes the sum of the FPM loss function employed and the EC regularization term:

$$Total LF = FPM Loss Function + {λ}_{coupling} * Norm ( {CC}^{T} - diag ( {CC}^{T} ) * I ) \qquad ( 2 )$$

In some embodiments, the FPM loss function employed may be the FPM loss function described in Kellman et al., although other FPM loss functions may be employed. The FPM loss function of Kellman et al. is listed below as equation (3):

$$FPM Loss Function = {Σ}_{N = 1}^{N} γ {‖ \vert {x}_{n}^{*} \vert ( C ) - \vert {x}_{n}^{\sim} \vert ‖}_{2}^{2} + ( 1 - γ ) {‖ {∠x}_{n}^{*} ( C ) - {∠x}_{n}^{\sim} ‖}_{2}^{2}$$

where N=training image total number,

$${x}_{n}^{*} = reconstructed image ,$$

$${x}_{n}^{\sim} = n th ground truth image ,$$

γ=loss function weight between phase (γ=0) and amplitude (γ=1) loss functions, |·|=amplitude of reconstructed image, and <=phase of reconstructed image.

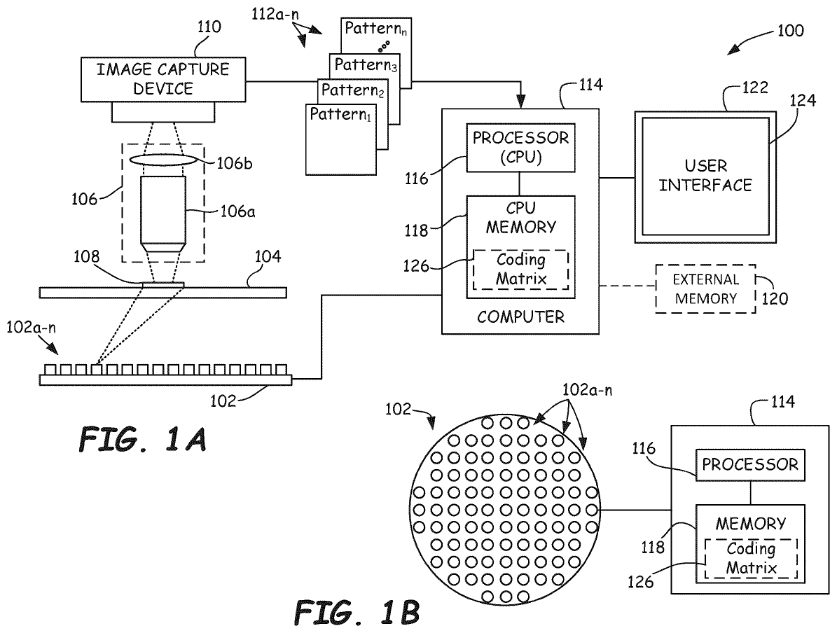

As will be described below with reference to FIGS. 1A-9, use of exclusivity coupling within the total loss function may improve coded illumination LED pattern selection by improving convergence (as well as the rate of convergence) during coded illumination pattern generation.

FIG. 1A illustrates an example Fourier ptychography microscopy (FPM) system 100 provided in accordance with embodiments of the disclosure. With reference to FIG. 1A, the FPM system 100 includes a light source array 102 having a plurality of light sources 102a-n configured to emit light onto a sample location 104.

An optical system 106 is configured to image at least a portion of a sample 108 positioned at the sample location 104. As shown in FIG. 1A, an image capture device 110 is configured to capture images (e.g., low-resolution images 112a-n) of sample 108 through optical system 106 under different light conditions provided by the plurality of light sources 102a-n of light source array 102. In some embodiments, the different light conditions may be selected based on a coding matrix that defines what pattern of light sources are to be used for each low resolution image. In some embodiments, the coding matrix may be determined by training a neural network with a loss function that includes a regularization term for exclusivity coupling that promotes diversity of and sparsity within light source patterns (e.g., as described previously with reference to equation (1) and as further described below).

A computer 114 having a processor 116 may be coupled to image capture device 110 and may receive images (e.g., low-resolution images) captured by image capture device 110 for storage in memory. In some embodiments, the images may be stored in a memory 118 associated with processor 116 (e.g., RAM, a hard drive, and/or another memory type). Alternatively or additionally, image data may be stored in an external memory 120 (e.g., local external memory, remote storage, cloud storage, or any combination thereof). A display 122 having a user interface 124 may be coupled to the processor 116, such as for displaying low-resolution images, reconstructed, high-resolution images, and/or the like.

Light source array 102 may include a uniform or non-uniform array of light sources 102a-n that may be controlled by the processor 116 or another suitable processor, microprocessor, controller, microcontroller, digital signal processor (DSP), or field programmable gate array (FPGA) configured to perform as a microcontroller, or the like.

In some embodiments, light sources 102a-n of light source array 102 may be individually controlled and operated alone or in combination with one or more light sources 102a-n (e.g., as defined by a coding matrix 126 shown stored within the memory 118, although other storage locations may be used, such as within external memory 120 or the memory of another processor used to control light source array 102).

Example light sources 102a-n may include light emitting diodes (LEDs), monochrome or single-bandwidth emission light sources, multiple bandwidth light sources (e.g., RGB LEDs), super-luminescent LEDs, laser diodes, especially semiconductor laser diodes, thermal emitters, fiber-based light sources, etc. All light sources 102a-n may be identical, or one or more light sources 102a-n may differ in at least one of the following characteristics: wavelength, spectral bandwidth, spatial emission characteristics, temporal emission characteristics such as continuous or pulsed operation, coherence parameters such as degree of temporal and/or spatial coherence, brightness or extent, and/or the like.

In some embodiments, a light source array 102 with between about 80 to 280 individually-controllable LEDs may be employed in an x-y grid, such as a 16×16 LED array, with each LED separated by approximately 1 to 10 mm and emitting at approximately 0.4 to 0.7 micrometers as shown in FIG. 1B. In one particular embodiment, the LEDs may be spaced by approximately 2.5-3.5 mm and employ wavelengths of 0.45, 0.51, and/or 0.62 micrometers. Other light source array arrangements, numbers of light sources, types of light sources, and/or emitting wavelengths may be employed. As mentioned, while processor 116 is shown controlling light source array 102 in FIG. 1B, in other embodiments, a different processor or other control mechanism may be employed to control operation of light source array 102.

Optical system 106 (FIG. 1A) may include an optical objective 106a and a focusing lens 106b, for example. Other optical components may be used. As stated, one of the benefits of FPM is that it allows use of low-cost, low-resolution optical components. In some embodiments, optical objective 106a may have a numerical aperture (NA) of approximately 0.05-0.9. Other NA optical objectives may be employed. In one or more embodiments, focusing lens 106b may be a tube lens, such as an achromatic tube lens, or another suitable lens. Image capture device 110 may include any suitable imaging device capable of imaging a sample through optical system 106 such as a CMOS sensor or the like. Example pixel sizes may range from about 1 micrometer to about 10 micrometers, although other pixel sizes may be used.

In some embodiments, processor 116 may be a central processing unit (CPU). In other embodiments, processor 116 may include and/or be implemented as one or more other computational resources such as, but not limited to, a microprocessor, a microcontroller, an embedded microcontroller, a digital signal processor (DSP), a field programmable gate array (FPGA) configured to perform as a microcontroller, or the like. Computer 114 may include any suitable computing device such as a tablet computer, laptop computer, desktop computer, a server, or the like.

Memory 118 and/or 120 may be any suitable type of memory, such as, but not limited to, one or more of a volatile memory and/or a non-volatile memory (e.g., RAM, DRAM, SRAM, cache, a hard drive, a combination of the same, etc.). In other words, memory 118 and/or 120 may include more than one type of memory. Memory 118 and/or 120 may have a plurality of instructions stored therein that, when executed by processor 116, cause processor 116 to perform various actions specified by one or more of the stored instructions. Code and data may be stored in a first type of memory (e.g., a hard drive) and transferred to a second type of memory for execution (e.g., RAM). In some embodiments, memory 118 and/or 120 may include either or both memory types.

Display 122 may include any suitable display such as a light-emitting diode (LED) display, liquid-crystal display (LCD), organic light-emitting-diode (OLED) display, or the like. User interface 124 may include one or more of a display screen or a touch panel and/or screen, an audio speaker, and a microphone, for example. In some embodiments, user interface 124 may be controlled by the processor 116, and functionality of user interface 124 may be implemented, at least in part, by computer-executable instructions (e.g., program code or software) stored in the memory 118 and/or executed by the processor 116.

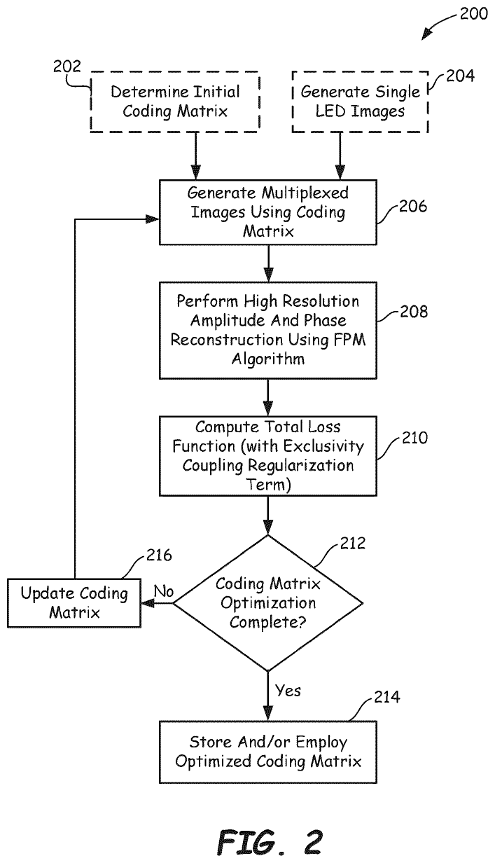

FIG. 2 illustrates an example method 200 of determining a coding matrix, such as the coding matrix 126 of FIG. 1A, for an FPM system in accordance with embodiments provided herein. With reference to FIG. 2, in block 202, an initial coding matrix is determined. In some embodiments, the coding matrix may contain a plurality of vectors each specifying an LED pattern for each low resolution image to be captured with an FPM system. In other words, each vector may specify which LEDs are to be illuminated (and/or a brightness for each LED to be illuminated) during image capture of a respective low resolution image. For example, if 50 low resolution images are to be captured for use during FPM reconstruction, the coding matrix may contain 50 vectors identifying the 50 LED patterns to be used to illuminate a sample during low resolution image capture. In some embodiments, the initial coding matrix may be randomly initialized. In other embodiments, an initial coding matrix may be determined based on a best guess for the coding matrix (e.g., based on factors such as the LED array being employed, the type of sample being imaged, the optical system employed within the FPM system, etc.). In at least one embodiment, LED patterns may be divided into bright field and dark field LED patterns in which only subsets of inner LEDs are illuminated for bright field LED patterns and only subsets of outer LEDs are illuminated for dark field LED patterns. In some embodiments, the initial coding matrix may include randomized bright field LED patterns (e.g., with randomized patterns of bright field LEDs only) and randomized dark field LED patterns (e.g., with randomized patterns of dark field LEDs only). Any other suitable method for determining the initial coding matrix may be employed.

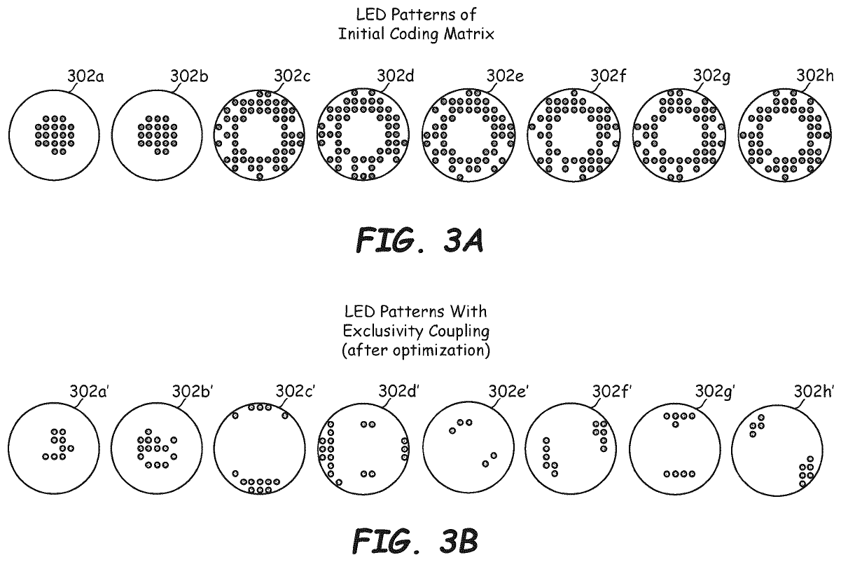

FIG. 3A illustrates LED patterns for an example initial coding matrix in accordance with embodiments provided herein. With reference to FIG. 3A, eight LED patterns 302a-302h are shown (e.g., corresponding to eight vectors within the initial coding matrix). As mentioned, in some embodiments, LED patterns may be divided into bright field LED patterns (e.g., such as LED patterns 302a and 302b) and dark field LED patterns (e.g., such as LED patterns 302c-302h) in which only subsets of inner LEDs are illuminated for bright field LED patterns and only subsets of outer LEDs are illuminated for dark field LED patterns. Other initial LED patterns may be specified by the initial coding matrix. FIG. 3B illustrates updated LED patterns 302a′-302h′ for the example initial coding matrix of FIG. 3A following optimization through use of the exclusivity coupling regularization term described above (e.g., equation (1)) in accordance with embodiments provided herein, as described further below.

With reference to FIG. 2, following determination of the initial coding matrix (in block 202), in block 204, single light source, low resolution images are generated (e.g., a single light source, such as an LED, is used to illuminate a sample during image capture). The single light source, low resolution images may be experimentally determined images (e.g., captured using an FPM system such as FPM system 100 of FIG. 1A) or simulated images. As an example, for a 256 LED array, 256 low resolution images may be generated, each illuminated with a different one of the LEDs in the LED array.

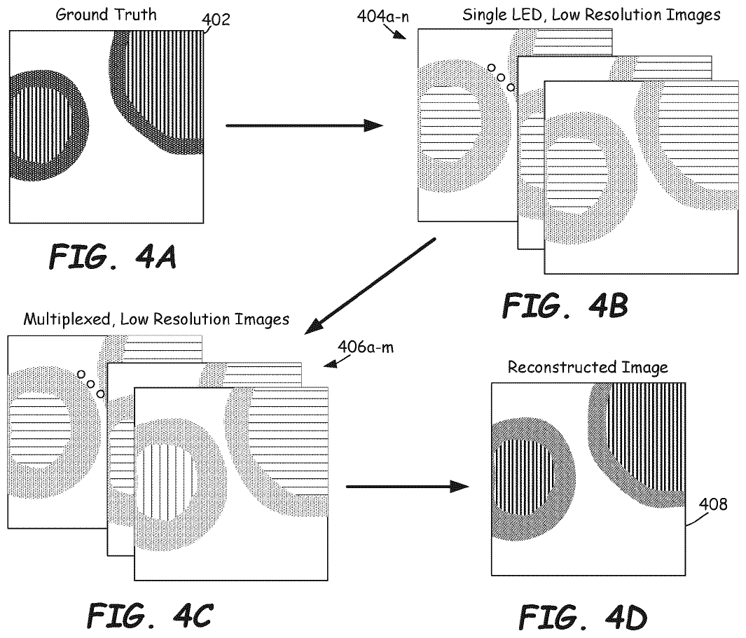

FIG. 4A illustrates an example, simulated ground truth 402, from which a plurality of low resolution, single-LED images 404a-n (FIG. 4B) may be generated. In some embodiments, ground truth 402 may be a combination of stock images representing any suitable phase and/or amplitude at high resolution. To generate low resolution images 404a-n, the forward model of the FPM reconstruction process may be used to simulate low resolution images from the ground truth (e.g., ground truth 402). Both bright field and dark field low resolution images may be simulated utilizing appropriate sections of the Fourier transformation(s) of the ground truth (e.g., ground truth 402). For example, low resolution images may be low pass filtered images of shifted Fourier transformations of the ground truth (e.g., with different amounts of shift dependent on different illumination angles). The simulated low resolution images may be further magnified based on the optical system employed.

Referring again to FIG. 2, in block 206, multiplexed images are generated from the single LED images and the coding matrix (e.g., the initial coding matrix or a subsequently determined coding matrix as described below). For example, for each LED pattern specified in the coding matrix, a plurality of single LED images may be combined (e.g., multiplexed) into a single image to simulate an image captured with the LED pattern. In some embodiments, the images may be combined by adding or averaging, such as using a weighted average of the images using the coding matrix values (e.g., for LED brightness) as weighting factors. For example, images may be added together pixel by pixel with each pixel weighted by the LED brightness values specified in the coding matrix. In one or more embodiments, all single LED images may be generated (e.g., experimentally or via simulation), where each LED is at full brightness. The coding matrix may specify a percentage brightness for each LED in an LED pattern, and a multiplexed image for an LED pattern may be generated by adding or averaging the relevant single LED images weighted by LED brightness specified in the coding matrix. In one or more other embodiments, single LED images may be generated, where the LEDs employed have varying brightnesses and where multiplexed images are generated by the coding matrix accounting for differences in LED brightness among the single LED images.

FIG. 4C illustrates example multiplexed, low resolution images 406a-m generated from the single-LED images 404a-n of FIG. 4B based on the coding matrix. For example, once generated, the low resolution, single-LED images 404a-n (FIG. 4B) may be added and/or averaged to form multiplexed, low resolution images 406a-m corresponding to the LED patterns specified in the coding matrix as described above.

In block 208, FPM reconstruction is performed on the coded images (e.g., generated in block 206). Specifically, a high resolution image is generated using high resolution amplitude and phase reconstruction with an FPM algorithm and the multiplexed images generated from the coding matrix (in block 206). In some embodiments, the FPM algorithm described in Kellman et al. may be employed. Any suitable FPM algorithm may be used for FPM reconstruction (e.g., any differentiable FPM algorithm). Other example FPM algorithms that may be employed include the alternating projection method described in R. W. Gerchberg and W. O. Saxton, “A practical algorithm for the determination of phase from image and diffraction plane pictures,” Optik, Bd. 35, pp. 227-246, (1972) and the maximum-likelihood estimation formulations of L. Bian, J. Suo, G. Zheng, K. Guo, F. Chen and Q. Dai, “Fourier ptychographic reconstruction using Wirtinger flow optimization,” Optics Express, Bd. 23, Nr. 4, pp. 4856-4866, 2 (2015) and L. Bian, J. Suo, J. Chung, X. Ou, C. Yang, F. Chen and Q. Dai, “Fourier ptychographic reconstruction using Poisson maximum likelihood and truncated Wirtinger gradient,” Scientific Reports, Bd. 6, Nr. 1, p. 27384, 7 (2016).

FIG. 4D illustrates an example high resolution, reconstructed image 408 that may be generated from the multiplexed, low resolution images 406a-m of FIG. 4C, for example.

Referring again to FIG. 2, in block 210, the total loss function (e.g., including the exclusivity coupling regularization term) is determined based on the high resolution image generated in block 208. As shown by equation (2), the total loss function includes the FPM loss function of the FPM algorithm employed plus the exclusivity coupling regularization term of equation (1). For example, the loss function of equation (3) of Kellman et al. may be computed and added to the exclusivity coupling regularization term (equation (1) above). Other FPM loss functions may be employed.

In general, the FPM loss function may be computed based on the FPM reconstructed image and a ground truth image. In some embodiments, simulated low resolution images may be obtained from the FPM reconstructed high-resolution image and compared to one or more of the multiplexed low-resolution images or one or more single light source, low resolution images (e.g., pixel by pixel) to determine if the reconstructed image accurately depicts the details of the low-resolution image(s). In some embodiments, this may include intentionally reducing the detail within the high-resolution image to approximate the level of detail within the low-resolution images. For example, the forward model of the FPM reconstruction process may be used to simulate low resolution images from the FPM reconstructed high-resolution image in a manner similar to that described above with reference to generating low resolution, single-LED images 404a-n from ground truth 402 (FIGS. 4A-4B).

The exclusivity coupling regularization term is determined based on the current coding matrix per equation (1) and the chosen value of hyperparameter λ_{coupling}. As mentioned, the exclusivity coupling regularization term promotes diversity and sparsity of light sources (e.g., LEDs) within light source patterns. As a simplified example, assume an LED array employs two LEDs, LED₁ and LED₂. Two low resolution images, Image₁ and Image₂, are generated. The brightness of LED₁ for Image₁ is C₁₁ and for Image₂ is C₂₁, and the brightness of LED₂ for Image 1 is C₁₂ and for Image₂ is C₂₂ (as shown in the table below).

| | LED 1 | LED 2 |
|---|---|---|
| Image 1 | C₁₁ | C₁₂ |
| Image 2 | C₂₁ | C₂₂ |

This information may be represented in a coding matrix C as follows:

$$C = ( \begin{matrix}{c}_{11} & {c}_{12} \\ {c}_{21} & {c}_{22}\end{matrix} ) , such that {C}^{T} = ( \begin{matrix}{c}_{11} & {c}_{21} \\ {c}_{12} & {c}_{22}\end{matrix} ) \qquad ( 4 )$$

$${CC}^{T} = ( \begin{matrix}{c}_{11}^{2} + {c}_{12}^{2} & {c}_{11} {c}_{21} + {c}_{12} {c}_{22} \\ {c}_{11} {c}_{21} + {c}_{12} {c}_{22} & {c}_{21}^{2} + {c}_{22}^{2}\end{matrix} ) \qquad ( 5 )$$

$$diag ( {CC}^{T} ) = ( \begin{matrix}{c}_{11}^{2} + {c}_{12}^{2} & 0 \\ 0 & {c}_{21}^{2} + {c}_{22}^{2}\end{matrix} ) \qquad ( 6 )$$

$$( {CC}^{T} - diag ( {CC}^{T} ) I ) = ( \begin{matrix}0 & {c}_{11} {c}_{21} + {c}_{12} {c}_{22} \\ {c}_{11} {c}_{21} + {c}_{12} {c}_{22} & 0\end{matrix} ) \qquad ( 7 )$$

$$norm ( {CC}^{T} - diag ( {CC}^{T} ) I ) = 2 {( {c}_{11} {c}_{21} + {c}_{12} {c}_{22} )}^{2} \qquad ( 8 )$$

$$EC Regularization Term = {λ}_{coupling} * 2 {( {c}_{11} {c}_{21} + {c}_{12} {c}_{22} )}^{2} \qquad ( 9 )$$

Equation (9) illustrates that the exclusivity coupling (EC) regularization term is largest when both LEDs (e.g., LED₁ and LED₂) are on during Image₁ or Image₂ (e.g., when C₁₁, C₂₁, C₁₂ and C₂₂ are non-zero). Also, the EC regularization term is a minimum when exclusivity is maximum (e.g., when LED₁ is on and LED₂ is off for Image₁, and LED₁ is off and LED₂ is on for Image₂). Thus, the exclusivity coupling regularization term discourages use of the same LED in multiple images, with the contribution of the exclusivity coupling regularization term tempered by hyperparameter λ_{coupling}. More generally, the exclusivity coupling regularization term promotes sparsity and diversity by promoting use of different LEDs for each image.

In block 212, a determination is made whether coding matrix optimization is complete. If coding matrix optimization is complete, the optimized coding matrix may be stored and/or employed as described below (in block 214); otherwise, in block 216, the coding matrix is updated. In some embodiments, coding matrix optimization may be deemed complete when the total loss function (e.g., computed in block 210) has flattened out over time and/or the gradient of the loss function drops below a predetermined threshold (e.g., approaches zero). Alternatively, coding matrix optimization may be deemed complete after a predetermined number of iterations of the coding matrix training/optimization steps (e.g., a predetermined number of iterations of blocks 206, 208, 210, 212, and 216). In some embodiments, tens to hundreds of iterations may be performed before coding matrix optimization is determined to be complete (e.g., assuming the coding matrix has not already been deemed optimized), although fewer or more iterations may be performed.

Returning to block 214, assuming that coding matrix optimization is complete, in block 214, the optimized coding matrix may be stored (e.g., in memory 118 of processor 116 or another suitable location) and/or employed during subsequent image acquisition and/or reconstruction operations using the FPM system 100.

Returning to block 216, assuming coding matrix optimization is not complete (e.g., as determined in block 212), the coding matrix may be updated. For example, based on the results of the total loss function in block 210, the coding matrix for the light array may be updated (e.g., the coding matrix values for each LED pattern specifying which LEDs are on or off, and/or the brightness of LEDs that are on, may be updated based on the gradient of the loss function). In other words, the coding matrix may be updated based on the gradient of the total loss function (e.g., determined in block 210). As a particular example, coding matrix values specifying LED brightnesses may be increased or decreased by an amount proportional to the gradient of the loss function. Any other suitable method may be used to update (e.g., optimize) the coding matrix by employing the proposed total loss function (e.g., with the exclusivity coupling regularization term).

Following updating of the coding matrix (in block 216), method 200 returns to block 206 where a new set of multiplexed images are generated using the updated coding matrix, followed by performing high resolution amplitude and phase reconstruction using the newly generated multiplexed images (in block 208). The total loss function is then computed (in block 210), and a determination is made whether coding matrix optimization is complete (in block 212). Blocks 216, 206, 208, 210, and 212 are repeated until coding matrix optimization is complete; after this, the coding matrix is stored and/or employed in block 214 as previously described.

FIG. 3B illustrates example updated LED patterns 302a′-302h′ for the example initial coding matrix described with reference to FIG. 3A following optimization through use of the exclusivity coupling regularization term described above (e.g., equation (1)) and method 200. As shown in FIG. 3B, following optimization of the coding matrix, significantly less clustering of neighboring LEDs is observed, LED diversity is increased, and patterns are more spatially separated. Additionally, optimization of the coding matrix is achieved faster with inclusion of the exclusivity coupling regularization term (as described below).

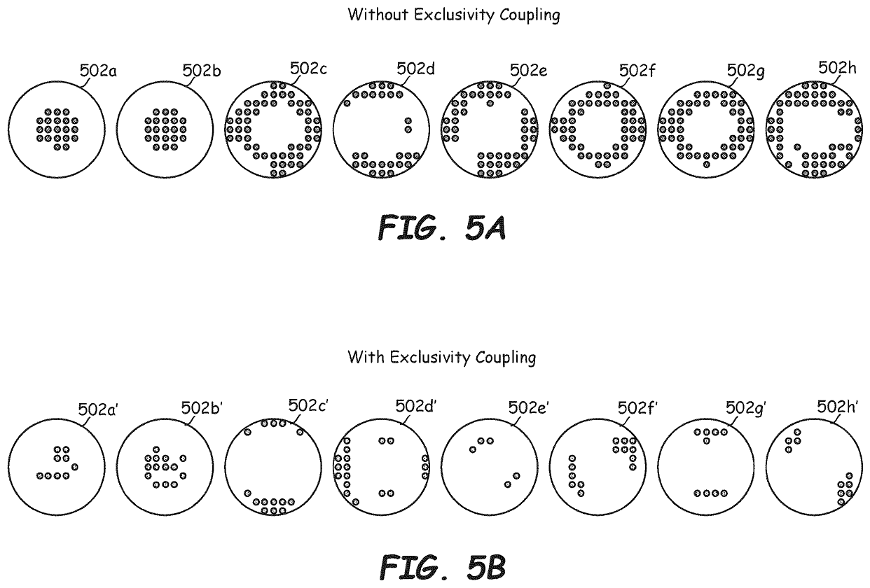

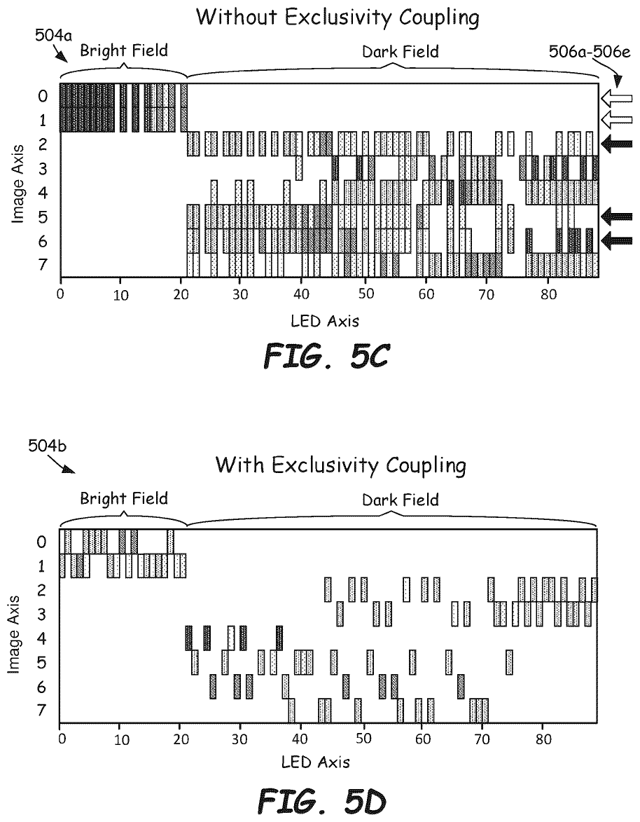

As a further example, FIGS. 5A and 5B illustrate example LED patterns following coding matrix optimization without and with an exclusivity coupling regularization term, respectively, in accordance with embodiments provided herein. With reference to FIG. 5A, LED patterns 502a-502h were determined from a coding matrix optimized without the exclusivity coupling regularization term (e.g., with λ_{coupling}=0), while the LED patterns 502a′-502h′ of FIG. 5B were determined from a coding matrix optimized using the exclusivity coupling regularization term (e.g., with λ_{coupling}>0). As shown in FIG. 5B, with the exclusivity coupling regularization term, the resultant light source patterns are more diverse, include fewer illuminated LEDs, and are overall more spatially separated. To further demonstrate, FIGS. 5C and 5D illustrate the coding matrices 504a and 504b corresponding to the LED patterns of FIGS. 5A and 5B, respectively. As shown in FIG. 5C, without the regularization term, significant clustering of LEDs may be found in both the bright field and dark field LED patterns. Specifically, without the exclusivity coupling regularization term, the loss function tends to form redundant LED groupings, such as LED groupings 506a-506e, when compared to the LED groupings of FIG. 5D formed through use of the exclusivity coupling regularization term in the loss function.

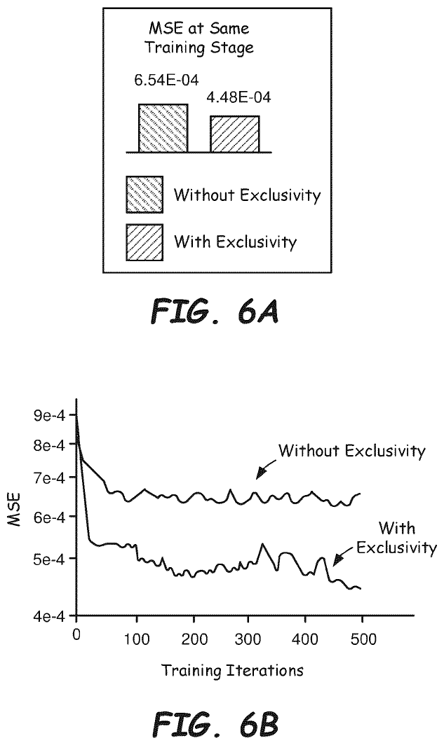

Use of the exclusivity coupling regularization term during coding matrix optimization may provide for faster and more desirable convergence, as shown in FIGS. 6A and 6B. For example, FIG. 6A illustrates a graphical comparison of the mean square error (MSE) observed within the loss function during training with and without inclusion of the exclusivity coupling regularization term. As shown in FIG. 6A, the MSE value observed during loss function convergence in which the exclusivity coupling regularization term is employed is approximately 32% lower than the MSE value observed during loss function convergence without inclusion of the exclusivity coupling regularization term.

Regarding convergence rate, FIG. 6B illustrates a graph of MSE versus training iterations during coding matrix optimization with and without use of the exclusivity coupling regularization term. As shown in FIG. 6B, the loss function converges faster and to a lower level when the loss function includes the exclusivity coupling regularization term.

Thus, through inclusion of the exclusivity coupling regularization term of equation (1), and appropriate selection of hyperparameter λ_{coupling}, LED patterns diversify, LED patterns contain fewer light sources, and LED patterns have light sources that are more spatially separated. Further, optimization of the coding matrix may be achieved faster and to a more desirable level.

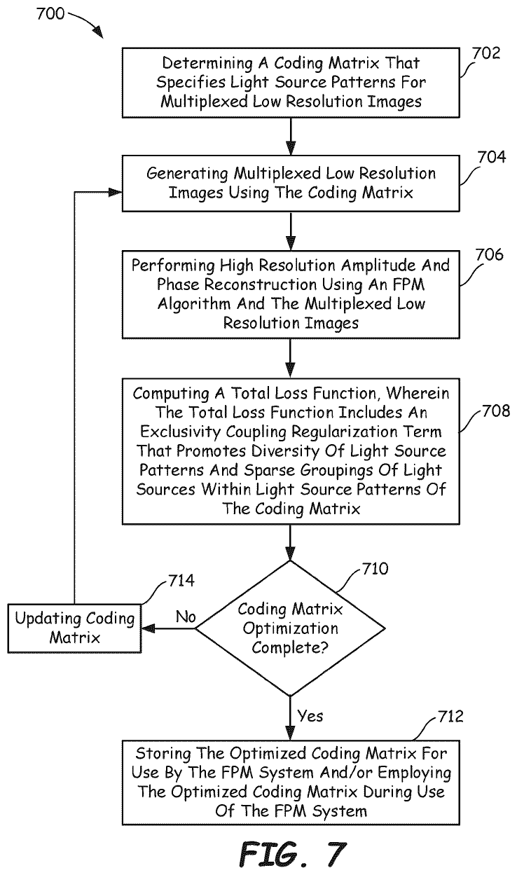

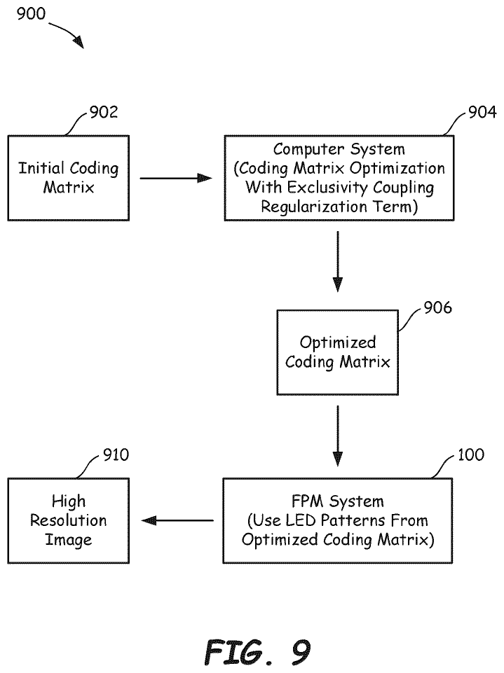

FIG. 7 illustrates a first example method 700 of determining coding patterns for light sources of an FPM system in accordance with embodiments provided herein. With reference to FIG. 7, in block 702, method 700 includes determining a coding matrix that specifies light source patterns for multiplexed low resolution images (e.g., an initial coding matrix, such as initial coding matrix 902 of FIG. 9). In block 704, method 700 includes generating multiplexed low resolution images using the coding matrix. In block 706, method 700 includes performing high resolution amplitude and phase reconstruction using an FPM algorithm and the multiplexed low resolution images. In block 708, method 700 includes computing a total loss function, where the total loss function includes an exclusivity coupling regularization term that promotes diversity of light source patterns and sparse groupings of light sources within light source patterns of the coding matrix (e.g., the total loss function of equation (2)). In block 710, method 700 includes determining if coding matrix optimization is complete. If the coding matrix optimization is complete, in block 712, the method 700 includes storing the optimized coding matrix for use by the FPM system (e.g., as the coding matrix 126 of FPM system 100 of FIG. 1A) and/or employing the optimized coding matrix during use of the FPM system. If the coding matrix optimization is not complete, in block 714, method 700 may include updating the coding matrix (e.g., based on the total loss function), and blocks 704, 706, 708, 710 and 714 may be repeated until coding matrix optimization is complete.

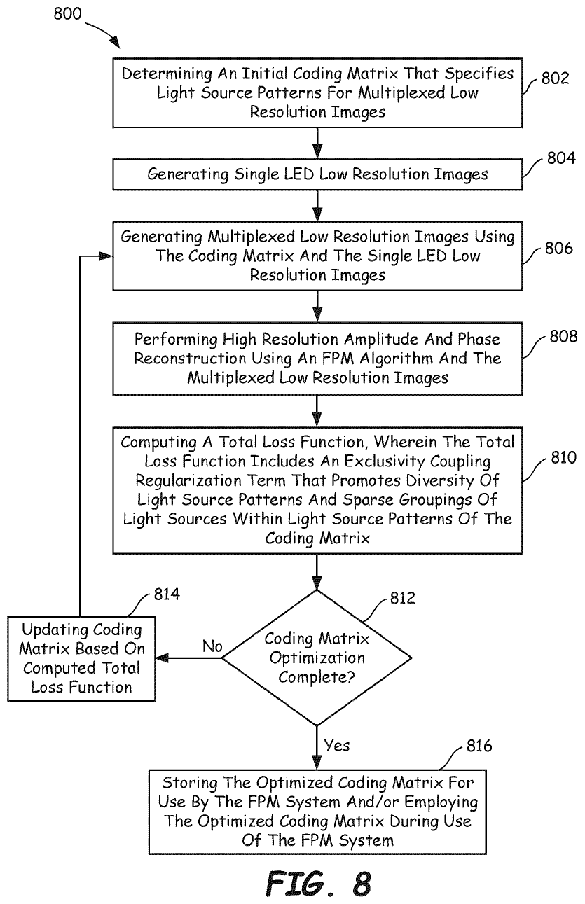

FIG. 8 illustrates a second example method 800 of determining coding patterns for light sources of an FPM system in accordance with embodiments provided herein. With reference to FIG. 8, in block 802, the method 800 includes determining an initial coding matrix that specifies LED patterns for multiplexed low resolution images (e.g., initial coding matrix 902 of FIG. 9). In block 804, the method 800 includes generating single LED low resolution images. In block 806, the method 800 includes generating multiplexed low resolution images using the coding matrix and the single LED low resolution images. In block 808, the method 800 includes performing high resolution amplitude and phase reconstruction using an FPM algorithm and the multiplexed low resolution images. In block 810, the method 800 includes computing a total loss function, where the total loss function includes an exclusivity coupling regularization term that promotes diversity of light source patterns and sparse groupings of light sources within light source patterns of the coding matrix. In block 812, the method 800 includes determining if coding matrix optimization is complete. If the coding matrix optimization is not complete, in block 814, the method 800 includes updating the coding matrix based on the computed total loss function. Thereafter, blocks 806, 808, 810, and 812 are repeated for the updated coding matrix. In some embodiments, if the coding matrix optimization is still not complete, blocks 806, 808, 810, 812, and 814 may be repeated until coding matrix optimization is complete. If the coding matrix optimization is complete, in block 816, the method 800 may include storing the optimized coding matrix for use by the FPM system and/or employing the optimized coding matrix during use of the FPM system. For example, the optimized coding matrix may be stored in the memory 118 of the computer 114 as the coding matrix 126 (FIG. 1A).

In some embodiments, employing the optimized coding matrix (e.g., the coding matrix 126) may include obtaining images (e.g., images 112a-n) of a sample (e.g., sample 108) positioned at a sample location (e.g., sample location 104), each of the images being illuminated using a different light source pattern specified within the coding matrix (e.g., coding matrix 126), and initiating FPM reconstruction to generate a reconstructed image based on the obtained images.

FIG. 9 illustrates a flow diagram of a process and system 900 for converting an initial coding matrix into an optimized coding matrix, and for use of the optimized coding matrix, in accordance with embodiments provided herein. With reference to FIG. 9, an initial coding matrix 902 is determined (e.g., as described above with reference to method 200) and is processed by a computer system 904 programmed to perform coding matrix optimization using the exclusivity coupling regularization term of equation (1), such as described above with reference to the method 200 of FIG. 2, the method 700 of FIG. 7, or the method 800 of FIG. 8, for example. This produces an optimized coding matrix 906 that may be employed within the FPM system 100 of FIG. 1A, for example, to illuminate a sample with LED patterns defined within the optimized coding matrix 906. The FPM system may capture and process low resolution images to produce a high resolution image 910 (e.g., using the image capture device 110 and the processor 116 of FIG. 1A). Other process flows and/or systems may be used.

One or more embodiments provided herein describe optimization of a coding matrix that specifies light source patterns for use during capture of low resolution images (e.g., employed during FPM reconstruction of a high resolution image). The coding matrix may be optimized by employing a loss function with an exclusivity coupling regularization term that promotes diversity of light source patterns and sparse groupings of light sources within light source patterns of the coding matrix. In some embodiments, optimization of the coding matrix may include reconstructing an image based on the coding matrix, computing a loss function based on the reconstructed image, and updating the coding matrix based on the computed loss function. In other embodiments, multiple images may be reconstructed and multiple loss functions may be computed (e.g., a loss function for each reconstructed image). Thereafter, the coding matrix may be updated based on multiple loss functions (e.g., by comparing the loss functions and picking one of the loss functions for updating the coding matrix, by combining, such as averaging, multiple loss functions for updating the coding matrix, or the like). In other words, batch reconstruction (e.g., serially or in parallel) may be performed to generate multiple loss functions, and the multiple loss functions may be used alone or in combination during coding matrix optimization. In yet other embodiments, multiple coding matrices may be optimized (e.g., in parallel) and employed to determine the optimal coding matrix for FPM reconstruction (e.g., via manifold optimization). Other optimization procedures may be employed.

The foregoing description discloses only example embodiments of the present invention; modifications of the above disclosed apparatus and methods which fall within the scope of the present invention will be readily apparent to those of ordinary skill in the art. Accordingly, while the present invention has been disclosed in connection with the example embodiments thereof, it should be understood that other embodiments may fall within the spirit and scope of the present invention, as defined by the following claims.

1. A method of determining coding patterns for light sources of a Fourier ptychography microscopy (FPM) system, the method comprising:
determining a coding matrix that specifies light source patterns for multiplexed low resolution images;
generating the multiplexed low resolution images using the coding matrix;
performing high resolution amplitude and phase reconstruction using an FPM algorithm and the multiplexed low resolution images;
computing a total loss function, wherein the total loss function includes an exclusivity coupling regularization term that promotes diversity of light source patterns and sparse groupings of light sources within light source patterns of the coding matrix;
determining whether coding matrix optimization is complete; and
when the coding matrix optimization is determined to be complete, at least one of:
storing the optimized coding matrix for use by the FPM system, or
employing the optimized coding matrix during use of the FPM system.

2. The method of claim 1, wherein when the coding matrix optimization is not complete, the method further comprises:
updating the coding matrix based on the total loss function;
generating updated multiplexed low resolution images using the updated coding matrix;
performing high resolution amplitude and phase reconstruction using the FPM algorithm and the updated multiplexed low resolution images;
computing an updated total loss function, wherein the updated total loss function includes the exclusivity coupling regularization term; and
determining whether coding matrix optimization is complete.

3. The method of claim 2, further comprising:
repeating updating the coding matrix, generating updated multiplexed low resolution images, performing high resolution amplitude and phase reconstruction, computing an updated total loss function, and determining whether coding matrix optimization is complete.

4. The method of claim 3, wherein updating the coding matrix comprises:
updating the coding matrix based on a gradient of a most recently computed total loss function.

5. The method of claim 3, wherein generating the updated multiplexed low resolution images comprises:
generating the updated multiplexed low resolution images using single LED low resolution images and the updated coding matrix.

6. The method of claim 5, wherein generating the updated multiplexed low resolution images using the updated coding matrix comprises:
combining single LED low resolution images based on the updated coding matrix.

7. The method of claim 1, wherein determining the coding matrix comprises:
determining an initial coding matrix.

8. The method of claim 7, wherein determining the initial coding matrix comprises:
randomly selecting values for the initial coding matrix.

9. The method of claim 1, wherein generating the multiplexed low resolution images comprises:
generating single LED low resolution images; and
generating the multiplexed low resolution images using the single LED low resolution images and the coding matrix.

10. The method of claim 1, wherein the exclusivity coupling regularization term includes λ_{coupling}*Norm(CC^{T}-diag(CC^{T})*I), wherein C is the coding matrix, C^{T} is a transpose of the coding matrix, and λ_{coupling} is a tunable hyperparameter.

11. A method of determining coding patterns for light sources of a Fourier ptychography microscopy (FPM) system, the method comprising:
determining an initial coding matrix that specifies LED patterns for multiplexed low resolution images;
generating single LED low resolution images;
generating multiplexed low resolution images using the initial coding matrix and the single LED low resolution images;
performing high resolution amplitude and phase reconstruction using an FPM algorithm and the multiplexed low resolution images;
computing a total loss function, wherein the total loss function includes an exclusivity coupling regularization term that promotes diversity of light source patterns and sparse groupings of light sources within light source patterns of the initial coding matrix;
determining whether coding matrix optimization is complete; and
when the coding matrix optimization is not complete
updating the initial coding matrix based on the computed total loss function to obtain an updated coding matrix,
generating updated multiplexed low resolution images using the updated coding matrix and the single LED low resolution images,
performing high resolution amplitude and phase reconstruction using the FPM algorithm and the updated multiplexed low resolution images,
computing an updated total loss function, wherein the updated total loss function includes the exclusivity coupling regularization term, and
determining whether coding matrix optimization is complete based on the updated total loss function.

12. The method of claim 11, further comprising:
updating the updated coding matrix; and
repeating generating updated multiplexed low resolution images, performing high resolution amplitude and phase reconstruction, and computing an updated total loss function until coding matrix optimization is complete.

13. The method of claim 12, wherein updating the updated coding matrix comprises:
updating the updated coding matrix based on a gradient of a most recently computed total loss function.

14. The method of claim 11, wherein determining the initial coding matrix comprises:
randomly selecting values for the initial coding matrix and separating initial light source patterns into bright field patterns and dark field patterns.

15. The method of claim 11, wherein the exclusivity coupling regularization term includes λ_{coupling}*Norm(CC^{T}-diag(CC^{T})*I), wherein C is the coding matrix, C^{T} is a transpose of the coding matrix, and λ_{coupling} is a tunable hyperparameter.

16. The method of claim 11, wherein when the coding matrix optimization is complete, the method further comprises:
storing the optimized coding matrix for use by the FPM system.

17. The method of claim 11, wherein when the coding matrix optimization is complete, the method further comprises:
employing the optimized coding matrix during use of the FPM system.

18. The method of claim 17, wherein employing the optimized coding matrix comprises:
obtaining images of a sample positioned at a sample location, each of the images being illuminated using a different light source pattern specified within the optimized coding matrix; and
generating a reconstructed image based on the images, the generating of the reconstructed image including initiating Fourier ptychography microscopy (FPM) reconstruction.

19. A Fourier ptychographic imaging system comprising:
a plurality of light sources configured to emit light onto a sample location;
an optical system configured to image at least a portion of a sample positioned at the sample location;
an image capture device configured to capture images of at last the portion of the sample through the optical system under different light conditions provided by the plurality of light sources;
a processor; and
a memory coupled to the processor and including a coding matrix that specifies light source patterns for use during capture of low resolution images by the image capture device, wherein the coding matrix includes light source patterns optimized using a loss function that includes an exclusivity coupling regularization term that promotes diversity of light source patterns and sparse groupings of light sources within light source patterns of the coding matrix; and
wherein the memory includes computer executable instructions stored therein that, when executed by the processor, cause the processor to:
obtain the images of at least the portion of the sample positioned at the sample location, each image illuminated using a different light source pattern specified within the coding matrix,
store the images; and
initiate Fourier ptychography microscopy (FPM) reconstruction, such that a reconstructed image is generated based on the stored images.

20. The Fourier ptychography imaging system of claim 19, wherein the exclusivity coupling regularization term includes λ_{coupling}*Norm(CC^{T}-diag(CC^{T})*I), wherein C is the coding matrix, C^{T} is a transpose of the coding matrix, and λ_{coupling} is a tunable hyperparameter.
